(19) United States
(12) Patent Application Publication
(10) Pub. No.: US 2008/0099080 A1
(43) Pub. Date: May 1, 2008

(54) FLUID DRAIN PLUG AND METHOD

(75) Inventors: Harpreet Singh Saini, Inkster, MI (US); Wallace R. Wicklund, Rochester Hills, MI (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/555,259

(22) Filed: Oct. 31, 2006

(51) Int. Cl. F16N 21/00

(52) U.S. Cl. 137/454.5; 184/1.5

(57) ABSTRACT

A drain plug (300) for a fluid passage (506), the drain plug (300) including a head portion (302), a shank portion (304) connected to the head portion (302), a threaded portion (306) that is connected to the shank portion (304) and includes a solid segment (312) that is located adjacent to the shank portion (304), and a partial portion (314) having at least one cutout (316), and a lead-in portion (308) that is connected to the threaded portion (306) and located adjacent to the partial portion (314). A fluid path is defined between the fluid passage (506) and the at least one cutout (316) of the drain plug (300) when the drain plug (300) is partially removed from the fluid passage (506).

### FIELD OF THE INVENTION

This invention relates to valves for fluid passage ports, including but not limited to valves used as drain plugs in draining passages used to drain fluids from an internal combustion engine.

### BACKGROUND OF THE INVENTION

Internal combustion engines have working fluids therein, such as coolant or oil, which are used during operation for cooling, lubrication, actuator actuation, and so forth. These fluids are typically contained in passages and reservoirs that are formed in the engine. When an engine operates, a temperature of the fluids contained therein tends to increase.

The fluids contained in the engine are often drained from the engine and replaced either after “hot” testing of the engine as part of a manufacturing process, or at regular intervals during service. To accomplish this, most engines have drain passages formed therein that are sealed by a “plug”, or, a removable element that opens a drain passage to allow fluid to drain therefrom when removed.

Draining an engine by removing a drain plug is effective, but may become inconvenient when draining warm fluids as well as when draining fluids from an engine in a manufacturing environment. The plugs currently in use require complete removal from the drain passage to open the drain passage and allow the fluid to be drained. The plug must be stored separately during the drain process, and must be reinstalled after draining is complete. In a manufacturing environment where a draining process is typically repeated many times by an operator, there is a risk of misplacing the drain plug during draining of the engine, and also a risk of cross-threading or otherwise damaging the plug or the engine upon reinsertion of the plug onto the engine.

There are several known methods of providing drain passages for internal combustion engines. Some examples can be seen in the following references: U.S. Pat. No. 4,078,763 by Yamamoto, issued on Mar. 14, 1978, that discloses a ball-type shut-off valve that can be screwed into an oil pan in a vehicle engine; U.S. Pat. No. 6,328,069 by Schumann et al., issued on Dec. 11, 2001, and discloses a device for purging contaminated oil from a lubrication conduit. These and other devices may partially address the known issues with drain passages, but are complicated and costly to implement, and require unique components to be installed onto an engine.

Accordingly, there is a need for an improved fluid drainage configuration that lessens of the risk of damage to the engine, which is more convenient when draining warm fluids from the engine, and that does not require unique or costly components to implement.

### SUMMARY OF THE INVENTION

A drain plug for a fluid passage, the drain plug including a head portion, a shank portion connected to the head portion, a threaded portion that is connected to the shank portion and includes a solid segment that is located adjacent to the shank portion, and a partial portion having at least one cutout, and a lead-in portion that is connected to the threaded portion and disposed adjacent to the partial portion. A fluid path is defined between the fluid passage and the at least one cutout of the drain plug when the drain plug is partially removed from the fluid passage.

### BRIEF DESCRIPTION OF THE DRAWINGS

FIG. 1 is a side view of a drain plug having a gasket.

FIG. 2 is a partial cross-section view of a component having a drain passage formed therein and a drain plug partially inserted into the drain passage.

FIG. 3 is a drain plug having a cutout in accordance with the invention.

FIG. 4 is a cross-section view of the drain plug having a cutout in accordance with the invention.

FIG. 5 is a partial cross-section view of a drain plug partially inserted into a drain passage of a component in accordance with the invention.

FIGS. 6A and 6B are cross-section views of a first alternate embodiment for a drain plug having a cutout in accordance with the invention.

FIGS. 7A and 7B are cross-section views of a second alternate embodiment for a drain plug having a cutout in accordance with the invention.

FIGS. 8A and 8B are cross-section views of a third alternate embodiment for a drain plug having a plurality of cutouts in accordance with the invention.

### DESCRIPTION OF A PREFERRED EMBODIMENT

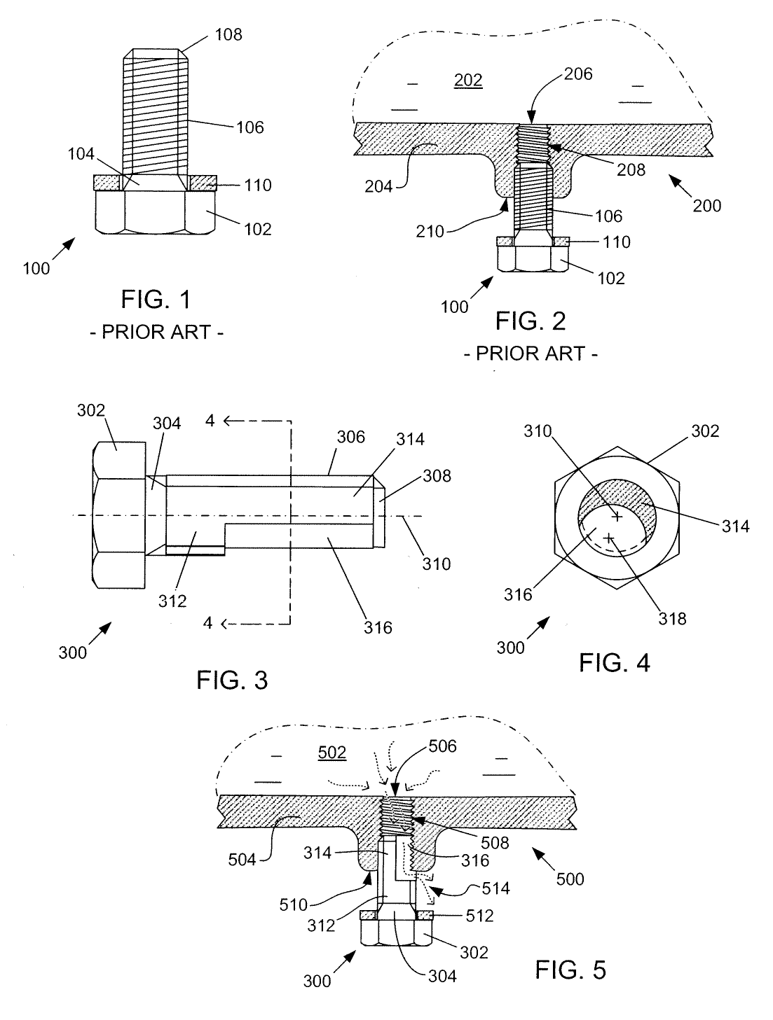

The following describes an apparatus for and method of providing a sealable fluid passage that can be used for draining of fluids, for example oil, from an internal combustion engine. An example of a known drain plug 100 is shown in FIG. 1. The drain plug 100 is essentially a fastener that is sealably installed into a threaded portion at a distal end of a drain passage, for example, a threaded opening in an oil pan of an engine. The drain plug 100 includes a head portion 102, a shank portion 104, a threaded portion 106, and a lead-in portion 108. A gasket 110, that is typically made of copper, is disposed on the shank portion 104 and be arranged to provide a seal with a mating part when the drain plug 100 is inserted into the mating part and tightened.

The drain plug 100 partially inserted into a mating component 200 is shown in partial cross section in FIG. 2. The component 200 encloses a cavity 202 that is arranged to collect a fluid therein. The fluid may be drained, at times, out of the cavity 202, for example, during an oil-change operation of an engine, or, after a hot-test of the engine in a manufacturing environment. The component 200 has a wall 204 that includes a drain passage 206 formed therein. A threaded section 208 surrounds the opening 206 and is arranged to receive the drain plug 100. The threaded section 208 is arranged to mate with the threaded portion 106 of the drain plug 100. A sealing face 210 is formed in the component 200 and is arranged to sealably engage the gasket 110 when the drain plug 100 is connected to the component 200 and tightened.

Draining of fluid occupying the cavity 202 in the component 200 requires complete removal of the drain plug 100 from the opening 206. While fluid is draining out of the component 200 through the opening 206, the drain plug must be retained separately by an operator. Moreover, fluid in the component 200 typically spills over and around the entire plug 100, covering the hands of the operator that is removing same from the opening 206 at an initial state immediately following removal of the drain plug 100. In the case where cleanliness is desired, and in cases when the fluid in the component 200 is hot or warm, it may not be desired to have any amount of fluid spilling onto the hands of the operator.

An improved drain plug 300 is shown in FIG. 3. The drain plug 300 includes a head portion 302, a shank portion 304, a threaded portion 306, and a lead-in portion 308. The threaded portion 306 is arranged to cooperate with threads formed into a mating part (not shown) as described above. The shank portion 304 is located between the head portion 302 and the threaded portion 306 and serves as a transition therebetween. A centerline 310 may be presumed as an imaginary axis of symmetry for the head portion 302 and the shank portion 304. The threaded portion 306 has a solid segment 312 and a partial segment 314, about the centerline 310. The partial segment 314 may advantageously form a cutout or cavity 316 therein. The cavity 316 is formed in the partial segment 314 and has a shape suitable for fluid to pass therethrough and suitable for use of a manufacturing method that can form the cavity 316 in the partial segment 314. In the embodiment shown, for example, the cavity 316 has a segmented-circular cross-sectional shape, but other shapes may be used. The cavity 316 extends between the lead-in portion 308 and the solid segment 312 of the threaded portion 306.

A cross-section view of the drain plug 300 at a position along the partial segment 314 thereof is shown in FIG. 4, to better illustrate the cavity 316. The cavity 316 is symmetrical about an offset-center point 318. In this embodiment, a drill or end-mill (not shown) may be used to form the cavity 316 by being applied to the drain plug 300 in a direction along the centerline 310 that is centered on the offset-center point 318. Cavities having other shapes may be formed by other cutting tools.

A partial cross-section view of the drain plug 300 partially inserted into an engine component 500 during a fluid-draining operation is shown in FIG. 5. The engine component 500 includes a quantity of fluid to be drained in an internal cavity 502 that is enclosed by a wall 504 having a drain opening 506 formed therein. The drain opening 506 is in fluid communication with a drain passage 508 that has threads formed on an inner surface that are arranged to mate with threads formed on the threaded segments 312 and 314 of the drain plug 300. The wall 504 has a sealing face 510 formed at an outer distal-end of the drain passage 508. The sealing face 510 is arranged to sealably-engage a gasket 512 that is located on the shank portion 304 of the drain plug 300 when the drain plug 300 is fully inserted in the drain passage 508 and tightened. In an alternate embodiment, the gasket 512 may be omitted or replaced by another type of seal, for example, an o-ring, and so forth.

In this embodiment, the drain plug 300 may advantageously be only partially retracted from within the drain passage 508 to allow for the fluid contained in the internal cavity 502 of the component 500 to drain out of the drain opening 506 through the passage 508. When the drain plug 300 is partially retracted, the cavity 316 that is in fluid communication with the drain opening 506 through the drain passage 508 extends past a distal end of the drain passage 508 and create a fluid path for a drain flow of fluid that extends from the internal cavity 502, through the drain opening 506, through a portion of the drain passage 508, through the cavity 315 of the drain plug 300, and out of the component 500 through an opening 514 created between the sealing face 510, the solid segment 312, and the partial segment 314. The flow of draining fluid is denoted by open-head dotted-line arrows. When draining is complete, and the flow of draining fluid has substantially ceased, the drain plug 300 is re-inserted fully into the drain passage 508, effectively sealing same from leakage of fluid past the drain plug 300.

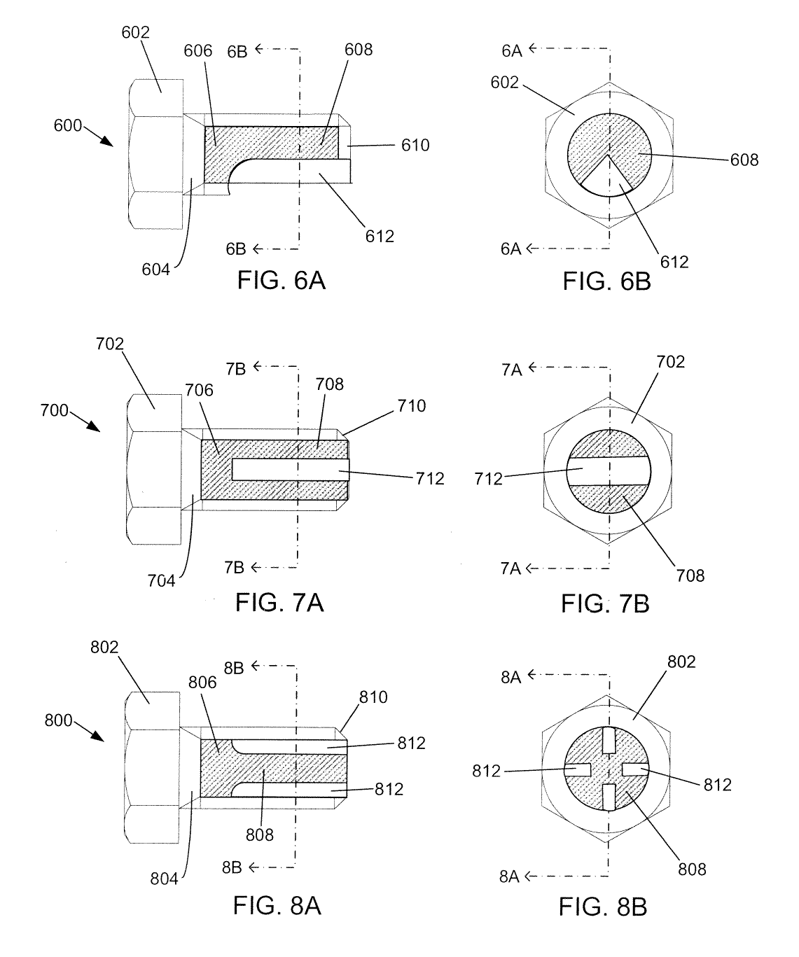

Some alternative embodiments of drain plugs having cavities with different shapes are shown in FIGS. 6A-8B. These embodiments are shown for illustration purposes only and are not exclusive of other equivalent shapes and combinations of cavities thereof. A first alternative embodiment of a drain plug 600 is shown in partial cross-section in FIGS. 6A and 6B. The drain plug 600 has a head portion 602, a shank portion 604, a solid segment 606, a partial segment 608, and a lead-in portion 610. The solid segment 606 and partial segment 608 have threads formed along an outer periphery thereof. The partial segment forms a cavity 612. The cavity 612 extends between the lead-in portion 610 and the solid segment 606. The cavity 612 has a substantially triangular cross-section and allows fluid to pass therethrough when the plug 600 is partially inserted into a threaded fluid passage.

A second alternative embodiment of a drain plug 700 is shown in partial cross-section in FIGS. 7A and 7B. The drain plug 700 has a head portion 702, a shank portion 704, a solid segment 706, a partial segment 708, and a lead-in portion 710. The solid segment 706 and partial segment 708 have threads formed along an outer periphery thereof. The partial segment forms a cavity 712. The cavity 712 extends between the lead-in portion 710 and the solid segment 706. The cavity 712 has a substantially rectangular cross-section, extends across a width of the partial segment 708, and allows fluid to pass therethrough when the plug 700 is partially inserted into a threaded fluid passage.

A third alternative embodiment of a drain plug 800 is shown in partial cross-section in FIGS. 8A and 8B. The drain plug 800 has a head portion 802, a shank portion 804, a solid segment 806, a partial segment 808, and a lead-in portion 810. The solid segment 806 and partial segment 808 have threads formed along an outer periphery thereof. The partial segment forms a plurality of cavities 812. The plurality of cavities 812 extend between the lead-in portion 810 and the solid segment 806. The plurality of cavities 812 each have a substantially rectangular cross-section, and allow fluid to pass therethrough when the plug 800 is partially inserted into a threaded fluid passage.

Use of a drain plug having at least one cavity formed therein, such as the embodiments described, is advantageous because it allows for selective fluid release out of an otherwise sealed passage. Such passages are typically used in internal combustion engines for draining of oil therefrom, but may also be used in pressure vessels, for pressure release from within the vessel or for draining of accumulated fluids in the vessel. The drain plug embodiments described herein have wide applicability because they are easy and inexpensive to implement, and their use is safe and convenient.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A drain plug for a fluid passage comprising:
a head portion;
a shank portion connected to the head portion;
a threaded portion that is connected to the shank portion and includes a solid segment that is disposed adjacent to the shank portion, and a partial portion having at least one cutout; and
a lead-in portion that is connected to the threaded portion and disposed adjacent to the partial portion;
wherein a fluid path is defined between the fluid passage and the at least one cutout when the drain plug is at least partially disposed within the fluid passage.

2. The drain plug of claim 1, wherein the head portion is arranged and constructed to mate with a tool.

3. The drain plug of claim 1, wherein an internal surface of the fluid passage forms threads, and wherein the threads are arranged to mate with the threaded portion of the drain plug.

4. The drain plug of claim 1, wherein the at least one cutout has a segmented-circular cross-section.

5. The drain plug of claim 1, wherein the at least one cutout has at least one of a triangular and a rectangular cross-section.

6. The drain plug of claim 1, further comprising an additional cutout formed in the partial segment, wherein the fluid path further includes the additional cutout.

7. The drain plug of claim 1, wherein the drain plug is made by forming the at least one cutout into a threaded portion of a fastener.

8. A drainage system for an internal combustion engine having a component that forms a fluid cavity that is arranged to collect a fluid therein, the component having a fluid passage formed therein, the drainage system comprising:
a drain plug disposed in the fluid passage, wherein the drain plug operably engages a threaded feature formed on an inner surface of the drain passage, the drain plug comprising:
a head portion,
a shank portion connected to the head portion,
a threaded portion that is connected to the shank portion and includes a solid segment that is disposed adjacent to the shank portion, and a partial portion having at least one cutout, and
a lead-in portion that is connected to the threaded portion and disposed adjacent to the partial portion;
wherein a fluid path is defined between the fluid cavity, the fluid passage, and the at least one cutout when the drain plug is partially disposed within the fluid passage.

9. The drainage system of claim 8, wherein the head portion of the drain plug is arranged and constructed to mate with a tool.

10. The drainage system of claim 8, wherein the at least one cutout in the threaded portion of the drain plug has a segmented-circular cross-section.

11. The drainage system of claim 8, wherein the at least one cutout in the threaded portion of the drain plug has at least one of a triangular and a rectangular cross-section.

12. The drainage system of claim 8, further comprising an additional cutout formed in the partial segment of the threaded portion of the drain plug, wherein the fluid path further includes the additional cutout.

13. The drainage system of claim 8, wherein the drain plug is made by forming the at least one cutout into a threaded portion of a fastener.

14. A method of draining fluid from a fluid cavity that is formed in a component, the component having a fluid passage formed therein and a drain plug disposed in the fluid passage, the drain plug operably and sealably engaged with the component, the method comprising the steps of:
using a tool to engage a head portion of the drain plug;
partially retracting the drain plug from the fluid passage;
exposing a cutout that is formed in a threaded portion of the drain plug;
creating a fluid path between the fluid cavity, the fluid passage, the cutout in the drain plug, and an opening that is defined between the drain plug and the component;
draining the fluid from the fluid cavity through the fluid path.

15. The method of claim 14, further comprising the step of using the tool to fully re-insert the drain plug into the fluid passage when the step of draining the fluid from the fluid cavity has been completed.
